(19) United States
(12) Patent Application Publication
(10) Pub. No.: US 2025/0217860 A1
(43) Pub. Date: Jul. 3, 2025

(54) Techniques for Preserving Memories and Experiences Through a Non-Fungible Token (NFT) Engine

(71) Applicant: TEACHERS INSURANCE AND ANNUITY ASSOCIATION OF AMERICA, New York, NY (US)

(72) Inventors: Sastry Vsm Durvasula, Phoenix, AZ (US); Swatee Singh, Livingston, NJ (US); Rares Ioan Almasan, Paradise Valley, AZ (US); Vamsi Pola, Concord, NC (US)

(21) Appl. No.: 18/400,778

(22) Filed: Dec. 29, 2023

(51) Int. Cl. G06Q 30/0601; G06F 3/01

(52) U.S. Cl. CPC G06Q 30/0621; G06F 3/011; G06Q 2220/00

(57) ABSTRACT

Techniques are described herein for system for preserving memories and experiences through a Non-Fungible Token (NFT) engine. An example system includes one or more memories storing a set of computer-readable instructions including the NFT engine and one or more processors interfacing with the one or more memories. The one or more processors are configured to execute the set of computer-readable instructions to cause the system to: receive data of a user from a time period, and execute the NFT engine to: analyze the data to classify a memory experienced by the user during the time period based on a memory threshold, generate, for display to the user, an NFT based on the memory, and mint the NFT corresponding to the memory to a blockchain, wherein a portion of the data associated with the memory is linked to the NFT.

### TECHNICAL FIELD

The present disclosure relates generally to techniques for preserving memories. In particular, the techniques described herein relate to preserving memories and experiences through a non-fungible token (NFT) engine.

### BACKGROUND

Frequently, a sense of loss accompanies the move into retirement, such as a loss of regularity, work-based social connections, and a distinct sense of purpose. Additionally, the memorable events and experiences that retirees have during this phase are frequently overlooked or forgotten over time. This sense of loss and irrelevance can lead to feelings of loneliness, boredom, and melancholy, which can negatively impact the mental and physical well-being of retirees. Accordingly, efforts to keep these memories alive and meaningfully and relatedly transferring them to future generations is an area of great interest.

Conventional techniques to preserve such memories suffer from several drawbacks. For example, conventional techniques often lack the ability to identify relevant, meaningful experiences for a user, and as a result, many such memories are not commemorated/memorialized and eventually forgotten. Moreover, these conventional techniques also often lack the ability to recreate the experience for the user.

Therefore, a need exists for techniques for preserving memories and experiences through an NFT engine that enables users to quickly and accurately memorialize, enrich, and recreate relevant memories.

### SUMMARY

In some aspects, the techniques described herein relate to a system for preserving memories and experiences through a Non-Fungible Token (NFT) engine, the system including: one or more memories storing a set of computer-readable instructions including the NFT engine; and one or more processors interfacing with the one or more memories, and configured to execute the set of computer-readable instructions to cause the system to: receive data of a user from a time period, and execute the NFT engine to: analyze the data to classify a memory experienced by the user during the time period based on a memory threshold, generate, for display to the user, an NFT based on the memory, and mint the NFT corresponding to the memory to a blockchain, wherein a portion of the data associated with the memory is linked to the NFT.

In some aspects, the techniques described herein relate to a system, wherein: the system further includes a sensory feedback system; the time period is a first time period; and the set of computer-readable instructions further cause the system to: access the data linked to the NFT during a second time period that is different from the first time period, display, via the sensory feedback system, a recreation of the memory for the user based on the data, and cause the sensory feedback system to provide sensory feedback to the user in conjunction with the recreation.

In some aspects, the techniques described herein relate to a system, wherein the sensory feedback includes one or more of: (i) visual feedback, (ii) audio feedback, (iii) haptic feedback, or (iv) olfactory feedback.

In some aspects, the techniques described herein relate to a system, wherein: the system further includes a plurality of sensors; the set of computer-readable instructions further cause the system to capture, by the plurality of sensors, the data of the user from the time period; and the data of the user includes one or more of: (i) heartbeat data, (ii) brainwave data, (iii) emotional context data, (iv) scent data, (v) temperature data, (vi) audio data, (vii) image data, or (viii) video data.

In some aspects, the techniques described herein relate to a system, wherein the set of computer-readable instructions further cause the system to: aggregate the data from a plurality of data sources including one or more of: (i) a wearable device, (ii) a smart home device, (iii) a social media platform, or (iv) a user computing device; and determine, by a contextual memory detection algorithm, whether the data satisfies the memory threshold based on a plurality of thresholds associated with the plurality of data sources.

In some aspects, the techniques described herein relate to a system, wherein the set of computer-readable instructions further cause the system to enrich the data associated with the memory by: layering, into the data from at least one of the plurality of data sources, one or more of: (i) a photo, (ii) a video, (iii) an audio track, or (iv) a text sequence corresponding to the memory that was not included in the data, or generating, by the contextual memory detection algorithm, a contextual narrative configured to explain one or more of: (i) a backstory, (ii) a character, (iii) an emotion.

In some aspects, the techniques described herein relate to a system, wherein the set of computer-readable instructions further cause the system to: determine an experience within the memory based on the data satisfying the memory threshold and an experience threshold that is different from the memory threshold; generate, for display to the user, a second NFT based on the experience; and mint the second NFT corresponding to the experience to the blockchain, wherein a second portion of the data associated with the memory is linked to the second NFT.

In some aspects, the techniques described herein relate to a system, wherein the set of computer-readable instructions further cause the system to: receive, from the user, an approval indication or a rejection indication corresponding to the NFT; responsive to receiving the rejection indication, prompt the user to provide supplemental data corresponding to the memory; and generate a second NFT based on the memory and the supplemental data.

In some aspects, the techniques described herein relate to a computer-implemented method for preserving memories and experiences through a Non-Fungible Token (NFT) engine, the method including: receiving, at one or more processors, data of a user from a time period; and executing, by the one or more processors, the NFT engine to: analyze the data to classify a memory experienced by the user during the time period based on a memory threshold, generate, for display to the user, an NFT based on the memory, and mint the NFT corresponding to the memory to a blockchain, wherein a portion of the data associated with the memory is linked to the NFT.

In some aspects, the techniques described herein relate to a computer-implemented method, wherein the time period is a first time period, and the method further includes: accessing, by the one or more processors, the data linked to the NFT during a second time period that is different from the first time period; displaying, via a sensory feedback system, a recreation of the memory for the user based on the data; and causing, by the one or more processors, the sensory feedback system to provide sensory feedback to the user in conjunction with the recreation.

In some aspects, the techniques described herein relate to a computer-implemented method, wherein the sensory feedback includes one or more of: (i) visual feedback, (ii) audio feedback, (iii) haptic feedback, or (iv) olfactory feedback.

In some aspects, the techniques described herein relate to a computer-implemented method, further including: capturing, by a plurality of sensors, the data of the user from the time period, wherein the data of the user includes one or more of: (i) heartbeat data, (ii) brainwave data, (iii) emotional context data, (iv) scent data, (v) temperature data, (vi) audio data, (vii) image data, or (viii) video data.

In some aspects, the techniques described herein relate to a computer-implemented method, further including: aggregating, by the one or more processors, the data from a plurality of data sources including one or more of: (i) a wearable device, (ii) a smart home device, (iii) a social media platform, or (iv) a user computing device; and determining, by the one or more processors executing a contextual memory detection algorithm, whether the data satisfies the memory threshold based on a plurality of thresholds associated with the plurality of data sources.

In some aspects, the techniques described herein relate to a computer-implemented method, further including: enriching, by the one or more processors, the data associated with the memory by: layering, into the data from at least one of the plurality of data sources, one or more of: (i) a photo, (ii) a video, (iii) an audio track, or (iv) a text sequence corresponding to the memory that was not included in the data, or generating, by the one or more processors executing the contextual memory detection algorithm, a contextual narrative configured to explain one or more of: (i) a backstory, (ii) a character, (iii) an emotion.

In some aspects, the techniques described herein relate to a computer-implemented method, further including: determining, by the one or more processors, an experience within the memory based on the data satisfying the memory threshold and an experience threshold that is different from the memory threshold; generating, by the one or more processors and for display to the user, a second NFT based on the experience; and minting, by the one or more processors, the second NFT corresponding to the experience to the blockchain, wherein a second portion of the data associated with the memory is linked to the second NFT.

In some aspects, the techniques described herein relate to a tangible, non-transitory computer-readable medium storing instructions for preserving memories and experiences through a Non-Fungible Token (NFT) engine that, when executed by one or more processors of a computing device, cause the computing device to: receive data of a user from a time period; and execute the NFT engine to: analyze the data to classify a memory experienced by the user during the time period based on a memory threshold, generate, for display to the user, an NFT based on the memory, and mint the NFT corresponding to the memory to a blockchain, wherein a portion of the data associated with the memory is linked to the NFT.

In some aspects, the techniques described herein relate to a tangible, non-transitory computer-readable medium, wherein the time period is a first time period, and the instructions, when executed, further cause the computing device to: access the data linked to the NFT during a second time period that is different from the first time period; display, via a sensory feedback system, a recreation of the memory for the user based on the data; and cause the sensory feedback system to provide sensory feedback to the user in conjunction with the recreation, and wherein the sensory feedback includes one or more of: (i) visual feedback, (ii) audio feedback, (iii) haptic feedback, or (iv) olfactory feedback.

In some aspects, the techniques described herein relate to a tangible, non-transitory computer-readable medium, wherein the instructions, when executed, further cause the computing device to: capture, by a plurality of sensors, the data of the user from the time period, and wherein the data of the user includes one or more of: (i) heartbeat data, (ii) brainwave data, (iii) emotional context data, (iv) scent data, (v) temperature data, (vi) audio data, (vii) image data, or (viii) video data.

In some aspects, the techniques described herein relate to a tangible, non-transitory computer-readable medium, wherein the instructions, when executed, further cause the computing device to: aggregate the data from a plurality of data sources including one or more of: (i) a wearable device, (ii) a smart home device, (iii) a social media platform, or (iv) a user computing device; determine, by executing a contextual memory detection algorithm, whether the data satisfies the memory threshold based on a plurality of thresholds associated with the plurality of data sources; and enrich the data associated with the memory by: layer, into the data from at least one of the plurality of data sources, one or more of: (i) a photo, (ii) a video, (iii) an audio track, or (iv) a text sequence corresponding to the memory that was not included in the data, or generate, by executing the contextual memory detection algorithm, a contextual narrative configured to explain one or more of: (i) a backstory, (ii) a character, (iii) an emotion.

In some aspects, the techniques described herein relate to a tangible, non-transitory computer-readable medium, wherein the instructions, when executed, further cause the computing device to: determine an experience within the memory based on the data satisfying the memory threshold and an experience threshold that is different from the memory threshold; generate, for display to the user, a second NFT based on the experience; and mint the second NFT corresponding to the experience to the blockchain, wherein a second portion of the data associated with the memory is linked to the second NFT.

Therefore, in accordance with the above, and with the disclosure herein, the present disclosure includes improvements in computer functionality or in improvements to other technologies at least because the present disclosure describes that, e.g., user memory/experience recording systems, may be improved or enhanced with the disclosed techniques for preserving memories and experiences through an NFT engine. That is, the present disclosure describes improvements in the functioning of user memory/experience recording systems itself or “any other technology or technical field” (e.g., user memory/experience recordation field) because the disclosed systems and methods improve and enhance the operation of user memory/experience recording systems by introducing memory/experience identification/recreation and transaction generation and recording using distributed ledgers and NFTs through the NFT engine in a manner that is unachievable using conventional techniques. This improves over the prior art at least because such conventional techniques were error-prone, as they lack the ability for accurately and consistently identifying, generating, recording, and/or recreating such memories/experiences and/or transactions.

Moreover, the present disclosure includes effecting a transformation or reduction of a particular article to a different state or thing, e.g., transforming or reducing the generation and/or recordation of user memory records from a non-optimal or error state to an optimal state.

Still further, the present disclosure includes specific features other than what is well-understood, routine, conventional activity in the field, or adding unconventional steps that demonstrate, in various embodiments, particular useful applications, e.g., executing an NFT engine to: analyze the data to classify a memory experienced by the user during the time period based on a memory threshold, generate, for display to the user, an NFT based on the memory, and/or mint the NFT corresponding to the memory to a blockchain, wherein a portion of the data associated with the memory is linked to the NFT, among others.

### BRIEF DESCRIPTION OF THE DRAWINGS

Advantages will become more apparent to those skilled in the art from the following description of the preferred embodiments which have been shown and described by way of illustration. As will be realized, the present embodiments may be capable of other and different embodiments, and their details are capable of modification in various respects. Accordingly, the drawings and description are to be regarded as illustrative in nature and not as restrictive.

The figures described below depict various aspects of the applications, methods, and systems disclosed herein. It should be understood that each figure depicts an embodiment of a particular aspect of the disclosed applications, systems and methods, and that each of the figures is intended to accord with a possible embodiment thereof. Furthermore, wherever possible, the following description refers to the reference numerals included in the following figures, in which features depicted in multiple figures are designated with consistent reference numerals.

FIG. 1A is a block diagram illustrating an example computing system, in accordance with various embodiments herein.

FIG. 1B is a block diagram illustrating an example NFT engine of FIG. 1A, in accordance with various embodiments herein.

FIG. 2 is an example distributed ledger system for recording transactions and executing smart contracts in a memory recordation system, in accordance with various embodiments herein.

FIG. 3 illustrates an example transaction recording identification information for a memory in a public distributed ledger, in accordance with various embodiments herein.

FIG. 4 depicts a user viewing a recreated memory in a virtual environment, in accordance with various embodiments herein.

FIG. 5 is a block diagram of an example computer-implemented method for preserving memories and experiences through an NFT engine, in accordance with various embodiments herein.

### DETAILED DESCRIPTION

The present disclosure relates to, inter alia, Distributed Ledger Technology (DLT) which enables digital systems to record the characteristics of assets (e.g., data corresponding to memories) along with transactions and operations performed on assets in which the transactions, operations, and their details are recorded in multiple places at the same time.

Unlike traditional databases, distributed ledgers have no central data store. The present disclosure relates to public ledgers, which are databases that are consensually shared and synchronized across multiple sites, institutions, or geographies. Such public ledgers are generally accessible by multiple people and systems, allow transactions to have public “witnesses,” and participants at each node of the network can access the recordings shared across that network and can own identical copies of it. Any changes or additions made to the public ledger are reflected and copied to all participants. Such public ledgers are generally built in a standardized manner, such that two relatively independent public ledgers may communicate through cross-ledger interoperability. This cross-ledger implementation may be mainly represented by asset swaps and asset transfers, and through such an implementation, the limitations of a single ledger may be avoided.

Of course, the systems and methods of the present disclosure may additionally, or alternatively, include private ledgers, federated ledgers, and/or any other suitable types or combinations of ledgers. For example, the present disclosure may include private ledgers, which are permissioned distributed ledger systems where a single authority or organization has write-access to the network and control over read permissions can be public or restricted if a public readability feature is included in the private ledger. Similarly, the present disclosure may include federated ledgers, which are hybrid public/private ledgers that are similar to private ledgers, but which remove the sole organization influence from the network and enable multiple entities to use the network for their benefit as a hub where the multiple organizations can simultaneously exchange information and work, thereby enabling participants to “fast forward” any kind of work requiring multiple entities to participate or approve transactions.

Furthermore, the present disclosure relates to smart contracts which are computerized transaction protocols that execute terms of a contract and can be self-executing. In effect, a smart contract has a conditional or an “if” component (i.e., the “left hand side” of a rule), and also has an executable or “then” component (i.e., called the “right hand side” of a rule), with the difference being that a smart contract “watches” a distributed ledger for its conditions to be met at which point it “fires” or executes and immutably records its actions (contract) on the distributed ledger.

Techniques, systems, apparatuses, components, devices, and methods are disclosed for utilizing a distributed ledger, or blockchain, for managing asset (e.g., vehicle) records. For example, in an asset recordation system, a distributed ledger may be maintained by nodes. The distributed ledger architecture may include a public distributed ledger which is accessible by multiple people and systems, is permissionless, and allows transactions to have public “witnesses.” Participants at each node of the network can access the recordings shared across that network and can own identical copies of it. Any changes or additions made to the public distributed ledger may be reflected and copied to all participants. The public distributed ledger may also obtain identification information for assets, which may uniquely identify an asset, and may be static and immutable in the public distributed ledger.

In certain embodiments, the distributed ledger architecture may also include a private distributed ledger where a single authority or organization has write-access to the network, and control over read permissions can be public or restricted if a public readability feature is included in the private ledger. If such read permissions are restricted, a user attempting to view the private ledger may need to enter a user name and password for authentication. For example, the private distributed ledger may obtain transaction-related documents for assets, such as contracts, title documents, deeds, mortgages, liens, lease documents, etc. The transaction-related documents may be dynamic and more memory intensive than the identification information and the ownership information. Moreover, the transaction-related documents may be more sensitive and private than the identification information and ownership information. Accordingly, the transaction-related documents may be managed by a single authority or organization rather than a public distributed ledger that may be accessed by any computing device.

In some embodiments, the distributed ledger architecture may also include a federated distributed ledger layer which requires nodes to receive permission to append data to the federated distributed ledger. Control over read permissions can be public or restricted if a public readability feature is included in the federated ledger. If such read permissions are restricted, a user attempting to view the federated ledger may need to enter a user name and password for authentication. The federated distributed ledger may obtain ownership information for properties, such as transfers of ownership of a property from one owner to another, the dates of the transfers, the sale prices of the transfers, encumbrances on the property, etc. The ownership information may be dynamic and more memory intensive than the identification information. Moreover, the ownership information may be more sensitive and private than the identification information. Accordingly, the ownership information is managed by the federated distributed ledger layer rather than a public distributed ledger layer that can be accessed by any computing device.

Regardless, in instances where multiple distributed ledgers communicate to accurately record asset transactions, these multiple distributed ledgers may reference each other so that a user may obtain asset information for the same asset from each ledger. For example, a user may mint a non-fungible token (NFT) representing an asset on a first public ledger, where the NFT includes identification and ownership information for the asset. The NFT may be wrapped in wrapped NFTs on a second public distributed ledger, such that the first and second ledgers may reference each other through the NFT and wrapped NFTs referring to the NFT. In other embodiments, the multiple distributed ledgers may reference each other using any suitable combination of identifiers and/or cross-chain tools, such as asset identifiers, creator identifiers, chain identifiers, digital certificate of authenticity identifiers, owner identifiers, transaction identifiers, user identifiers, RDF identifiers, location identifiers, etc.

Further, the systems and methods of the present disclosure include users interacting with other users via digital tokens. For example, online digital identities, as implemented by use of digital tokens on a blockchain, may provide a single source of user authentication for a given user and reduce digital waste across networks. Such digital identities may be used in a variety of ways to identify respective users.

Namely, digital tokens may be associated with users where such digital tokens may be used to provide respective digital identities to authenticate a select group users for the purpose transacting with, or associating users with, people or entities. Such digital tokens may provide access or privileges in either real-world or virtual environments, such as sporting events, concerts, in videogames, or in the Metaverse. In various embodiments, a user's digital token(s), and/or related public and private keys, may be used to identify and/or authenticate a user and server as a single source of authenticity and identification to a variety of entities, persons, and related systems.

Therefore, the systems and methods of the present disclosure may broadly enable a user to engage with other users through a secure distributed ledger architecture that may also connect with a user's online digital identity in an environment, such as the Metaverse. Transactions associated with a particular asset may be generated, executed, and recorded on the distributed ledger, and the transaction may then be reflected and/or otherwise represented in the virtual environment. For example, a transaction recorded on the distributed ledger of the present disclosure may correspond to a particular user's memory of attending a sporting event (e.g., seated in a stadium) at a particular time. In this example, the data recorded on the blockchain corresponding to the maintenance transaction may include or link to image data, video data, audio data, olfactory data, temperature data, and/or other data associated with the sporting event at the particular time. Based upon this transaction, the user's virtual profile may include a virtual recreation of the user's memory in the virtual environment to allow the user to relive the memory/experience of attending the sporting event.

As mentioned, one type of distributed ledger, a blockchain, is comprised of groupings of transactions organized together into a “block,” and ordered sequentially. While the distributed ledgers discussed herein are referred to in the context of a blockchain, this is merely one example of a distributed ledger. Distributed ledgers may also include a tangle, a block lattice, or other directed acyclic graph (DAG). In any event, nodes may join and leave the blockchain network over time and may obtain blocks from peer nodes that were propagated while the node was gone. Nodes may maintain addresses of other nodes and exchange addresses of known nodes with one another to facilitate the propagation of new information across the network in a decentralized, peer-to-peer manner.

The nodes that share the ledger form what is referred to herein as the distributed ledger network. The nodes in the distributed ledger network validate changes to the blockchain (e.g., when a new transaction and/or block is created) according to a set of consensus rules. The consensus rules depend on the information being tracked by the blockchain and may include rules regarding the chain itself. For example, a consensus rule may include that the originator of a change supply a proof-of-identity such that only approved entities may originate changes to the chain. A consensus rule may require that blocks and transactions adhere to format requirements and supply certain meta information regarding the change (e.g., blocks must be below a size limit, transactions must include a number of fields, etc.). Consensus rules may include a mechanism to determine the order in which new blocks are added to the chain (e.g., through a proof-of-work system, proof-of-stake, etc.).

Additions to the blockchain that satisfy the consensus rules are propagated from nodes that have validated the addition to other nodes recognized by the validating node. If all of the nodes that receive a change to the blockchain validate the new block, then the distributed ledger reflects the new change as stored on all nodes, and it may be said that distributed consensus has been reached with respect to the new block and the information contained therein. Any change that does not satisfy the consensus rule is disregarded by validating nodes that receive the change and the change is not propagated to other nodes. Accordingly, unlike a traditional system which uses a central authority, a single party cannot unilaterally alter the distributed ledger unless the single party can do so in a way that satisfies the consensus rules. The inability to modify past transactions leads to blockchains being generally described as trusted, secure, and immutable.

The validation activities of nodes applying consensus rules on a blockchain network may take various forms. In one embodiment, the blockchain may be viewed as a shared spreadsheet that tracks data such as the ownership of assets. In another embodiment, the validating nodes execute code contained in “smart contracts” and distributed consensus is expressed as the network nodes agreeing on the output of the executed code.

As previously mentioned, a smart contract is a computer protocol that enables the automatic execution and/or enforcement of an agreement between different parties. In particular, the smart contract may be computer code that is located at a particular address on the blockchain. In some cases, the smart contract may run automatically in response to a participant in the blockchain sending funds (e.g., a cryptocurrency such as bitcoin, ether, or other digital/virtual currency) to the address where the smart contract is stored. Additionally, smart contracts may maintain a balance of the amount of funds that are stored at their address. In some scenarios when this balance reaches zero the smart contract may no longer be operational.

The smart contract may include one or more trigger conditions, that, when satisfied, correspond to one or more actions. For some smart contracts, the action(s) performed may be determined based upon one or more decision conditions. In some instances, data streams may be routed to the smart contract so that the smart contract may detect that a trigger condition has occurred and/or analyze a decision condition.

Blockchains may be deployed in a public, decentralized, and permissionless manner meaning that any party may view the distributed ledger, submit new information to be added to the ledger, or join the network as a validating node. Other blockchains are private (e.g., permissioned ledgers) that keep chain data private among a group of entities authorized to participate in the blockchain network. Other blockchain implementations may be both permissioned and permissionless whereby participants may need to be validated, but only the information that participants in the network wish to be public is made public.

In some embodiments, a distributed ledger includes multiple blockchains such as a main blockchain and several side chains operating independently of the main blockchain. The side chains then interact with the main blockchain to provide some of the transaction data from the side chains to the main blockchain. In this manner, the side chains can be permissioned or private while the main blockchain is public or available to a larger number of entities than the side chains. Non-sensitive information from the side chains may be shared on the main blockchain. Also in some embodiments, a distributed ledger includes multiple layers or separate blockchains executing in parallel that are maintained by the same validating nodes. Some of the transaction data from the blockchain for the first layer may be provided to the blockchain for the second layer or vice versa.

In one example, a distributed ledger in an asset recordation system may be maintained by validating nodes which transmit data to remote systems using one or more public and/or private networks, such as a private enterprise network, the Internet, a cellular router, a backhaul Internet or other type backhaul connection. The validating nodes receive transactions broadcasted to the distributed ledger network by for example, user devices. The nodes then validate the broadcasted transactions. In another example, the validating nodes execute code contained in smart contracts and other devices act as “evidence oracles” which provide evidence related to title transfers, maintenance updates, etc. to the blockchain. Oracles may be systems, devices, or entities that connect a deterministic system with a non-deterministic system or data source.

Regardless, the systems and methods of the present disclosure may rely on and/or otherwise include this distributed ledger technology to enable users (e.g., retirees) to track and record memories and experiences from their lives. As a result, a user could maintain and enrich memories/experiences from their lives on the blockchain as a trusted, secure, and/or immutable form of record-keeping/documentation. For example, such a user may record biometric data, emotional context data, scent data, temperature data, audio data, image data, video data, and/or any other data related to any particular memory/experience as part of an NFT and/or other digital asset recorded on the blockchain or other distributed ledger.

As part of this distributed ledger recordation of user memory/experience data, users can mint an NFT for each new memory/experience and/or prior memories/experiences. This unique NFT may serve as an additional (or single) ownership credential that may be transferred to a buyer or other interested party and can subsequently be used as a basis for tracking all transactions involving the memory/experience. In fact, the NFT may be linked to and/or otherwise indicate the corresponding user data, such that, the current owner may recreate and/or otherwise experience the memory/experience (e.g., using a virtual reality (VR) system/headset).

In the following description, for the purposes of explanation, specific details are set forth in order to provide a thorough understanding of various embodiments and examples. Various embodiments may be practiced without these specific details. The figures and description are not intended to be restrictive.

### Example Computing Systems and Components for Executing Memory/Experience Preservation on a Distributed Ledger Network

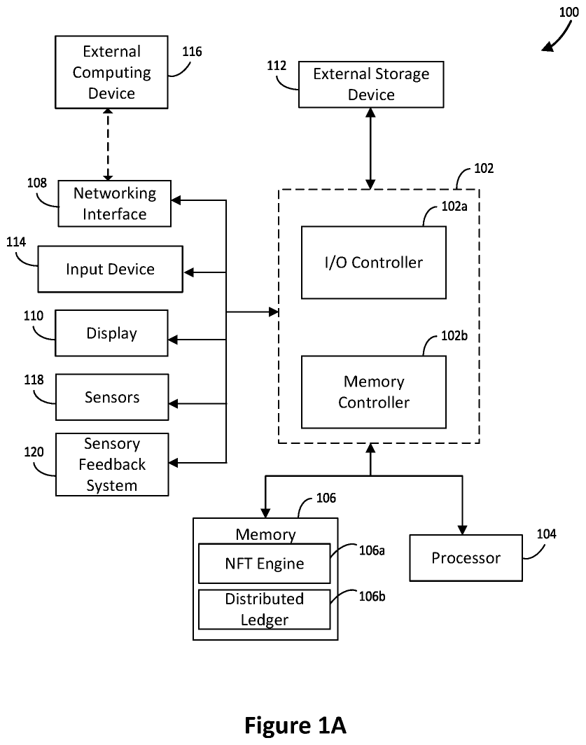

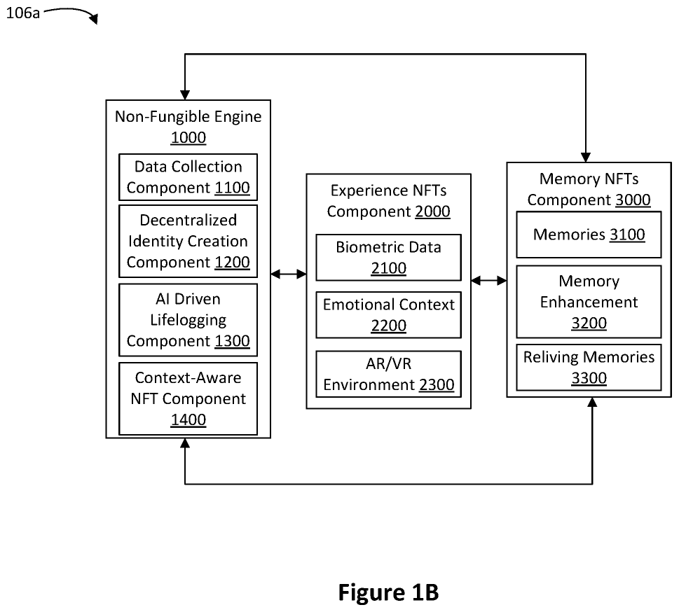

FIG. 1A is a block diagram illustrating an example computing system 100 in accordance with an illustrative embodiment, in accordance with various embodiments herein. In other examples, fewer, additional, or different components may be present. The computing system 100 may be any suitable computing machine such as a tablet, smart phone, mobile device, laptop computer, desktop computer, server, remote client device, gaming device, smart television device, wearable computer, or any combination thereof. The computing system 100 may include at least one processor 104 coupled to a central hub 102. The central hub 102 may include a memory controller 102b and an input/output (I/O) controller 102a. Each of a memory 106, a networking interface 108, a display 110, an external storage device 112, an input device 114, one or more sensors 118, and a sensory feedback system 120 may be coupled to the central hub 102. In certain instances, the memory 106 may be coupled specifically to the memory controller 102b; and the external storage device 112, the input device 114, networking interface 108, and the display 110 may be coupled to the I/O controller 102a. Other examples of the computing system 100 may be characterized by different architectures.

Broadly speaking, the computing system 100 may represent a node of a distributed ledger system. This distributed ledger system may include a public ledger, a private ledger, a federated ledger, and/or any other suitable ledgers or layers and combinations thereof. For example, the computing system 100 may include an Internet of Things (IoT)/device layer (not shown) stored in memory 106. The IoT layer may be a system of interrelated computing devices, mechanical and digital machines, objects, animals or people that are provided with unique identifiers (UIDs) and have the ability to transfer data over a network (via networking interface 108) without requiring human-to-human or human-to-computer interaction.

Users (e.g., retirees, etc.) may interact through the computing system 100 by recording transactions of memories, experiences, and/or other assets via the distributed ledger 106b. Additionally, other applications, application programming interfaces (APIs), algorithms/models, engines (e.g., the NFT engine 106a), and/or intelligent user interfaces may also be stored in the memory 106 and utilized with the distributed ledger 106b to facilitate the recordation and/or transfer of assets.

The assets may be real world assets, virtual assets, intellectual assets (e.g., patents, trademarks, copyrights, etc.), and/or any suitable type of assets or combinations thereof. However, as mentioned, the assets described herein may generally be or include memories/experiences of a particular user that are captured and/or otherwise described by data (e.g., biometric data, audio/visual data, scent data, temperature data, etc.) that is representative of the conditions the user experienced during and/or as part of the memory/experience.

As referenced herein, a “memory” may be a collection of data across a period of time that all generally corresponds to a longer-form event, and an “experience” may be a sub-set of the data comprising a particular memory that corresponds to a shorter-form event within the memory. For example, a user may have a memory of attending a birthday party. During this birthday party, the user may have an interaction with a particular guest that lasts less than the entire length of the birthday party, but which was particularly memorable. In this example, the user's memory may include all data from the time period comprising the entire birthday party (e.g., from the party's beginning to end), and the user may also have an experience within that time period including only the data gathered during the interaction with the particular guest. Thus, the single event may comprise a memory (e.g., the birthday party) and an experience (e.g., the particular guest interaction at the birthday party).

Moreover, while the techniques described herein are largely referenced as recording a “memory” on a distributed ledger, this is for the purposes of discussion only. It should be appreciated that transactions recorded on distributed ledgers described herein may be or include memories and/or experiences.

In any event, the memory information included in records of the distributed ledger 106b and/or otherwise utilized by the processor 104 when updating the distributed ledger 106b may include sensor data and/or other contextual data collected during the memory/experience and/or supplied following the memory/experience. For example, the memory information may include life logging information collected from the one or more sensors 118, which may include smart devices (e.g., smartwatches, smart rings, smart glasses, smart home cameras/devices, etc.), augmented reality (AR)/VR headsets, IoT devices, and/or any other suitable device(s) that may be configured to capture data such as heartbeat data, brainwave data, emotional context data, scent data, temperature data, audio data, image data, video data, and/or any other data type or combinations thereof. Further, the NFT engine 106a may include instructions that cause the processor 104 to aggregate the data from other data sources, such as a social media platform, a user computing device, and/or other connected devices.

Accordingly, the distributed ledger 106b may generally include information corresponding to user memories. As an example, the distributed ledger 106b may include date/time information, biometric data, contextual data, emotional state data, and/or any other suitable data corresponding to each memory/experience recorded on the distributed ledger 106b. The distributed ledger 106b may further include ownership information for the memory/experience, such as the name, address, phone number, unique identification number, etc., of an entity that owns the memory/experience, and/or identification information for each previous owner of the memory/experience.

In any event, the computing system 100 may also communicate with external computing devices 116 (also referenced herein as “nodes”) to perform the validation/consensus process required to update/change entries included in the distributed ledger 106b. In certain embodiments, these external computing devices 116 may also be or include integration devices and/or legacy systems that store and/or otherwise include identification information, ownership information, and/or any other suitable information for memories that is relevant to the entries in the distributed ledger 106b. For example, the integration devices of the external computing devices 116 may be or include middleware used to transform, route, clone, and/or translate data between multiple computing systems 100.

When the computing system 100 receives and/or otherwise has the necessary memory information, and the processor 104 successfully executes the validation/consensus calculations/process, then the processor 104 may record any suitable memory information into the distributed ledger 106b. As part of this recordation in the distributed ledger 106b, the processor 104 may mint a token (e.g., an NFT) representing the memory, where the token acts as a digital deed or certificate of ownership of the memory.

In addition to minting an NFT representing the memory, the processor 104 may communicate with a third-party certificate authority (e.g., included as part of an external computing device 116) to generate a certificate of authenticity for the owner of the memory, and/or the processor 104 may mint and/or otherwise receive a verifiable credential from an issuer (e.g., prior owner) corresponding to the memory. Such a verifiable credential may be or include a hash value representative of a transaction that occurred corresponding to the memory. Therefore, the verifiable credential may represent authenticated transactions corresponding to the memory without storing the memory directly in the distributed ledger 106b. The certificate and/or verifiable credential may include a description of the memory, such as a name of the original experiencer of the memory, a location of the memory (e.g., town, country, venue, etc.) a unique identification number for the memory, etc.; and identification information for the owner of the memory, such as a name of the entity that currently owns the memory, an address of the current owner, a phone number of the current owner, etc. The certificate and/or verifiable credential may also include information corresponding to the memory that is recorded in and/or otherwise associated with the distributed ledger 106b, such as a reference to the NFT, certificate, and/or verifiable credential representing the memory (e.g., a token ID and/or smart contract address for the NFT).

For example, a first user may experience an event that is later recorded on the distributed ledger 106b as a memory. This first user may want to pass the memory on to a second user (e.g., a child, grandchild), and may authorize a transaction to transfer the memory from their account to the second user's account on the distributed ledger 106b. As part of this transaction, the first user may issue a verifiable credential corresponding to the memory that is configured to indicate the transfer of ownership from the first user to the second user. Thus, the second user may receive the verifiable credential from the first user and may proceed to access the memory via the distributed ledger 106b.

Regardless, the operations described herein and with respect to FIGS. 1A-5 may be performed partially or wholly on, or otherwise using, the processor 104. For example, the processor 104 can execute one or more operations for generating and/or applying an NFT engine 106a for analyzing data to classify a memory experienced by a user based on a memory threshold, generate an NFT based on the memory, mint the NFT corresponding to the memory to a blockchain, and/or other suitable functions or combinations thereof. In some examples, the NFT engine 106a may be or may include one or more artificial intelligence (AI)/machine learning (ML) models. The processor 104 can execute instructions stored in the memory 106 to perform the operations. The processor 104 can include one processing device or multiple processing devices or cores. For example, the processor 104 may be or include one or more central processing units (CPUs), one or more graphics processing units (GPUs), one or more Field-Programmable Gate Arrays (FPGAs), one or more application-specific integrated circuits (ASICs), one or more microprocessors, etc.

Further, the processor(s) 104 may be connected to the memory 106 via a computer bus responsible for transmitting electronic data, data packets, or otherwise electronic signals to and from the processor(s) 104 and memory 106 in order to implement or perform the machine readable instructions, methods, processes, elements or limitations, as illustrated, depicted, or described for the various flowcharts, illustrations, diagrams, figures, and/or other disclosure herein.

The processor(s) 104 may interface with the memory 106 via the computer bus to execute an operating system (OS). The processor(s) 104 may also interface with the memory 106 via the computer bus to create, read, update, delete, or otherwise access or interact with the data stored in the memory 106 and/or the external storage device 112 (e.g., a relational database, such as Oracle, DB2, MySQL, or a NoSQL based database, such as MongoDB). The data stored in the memories 106 and/or the external storage device 112 may include all or part of any of the data or information described herein, including, for example, training data and/or memory data (e.g., sensor data, context data, etc.) or other information of the user or a corresponding memory. The memory 106 may include one or more persistent memories (e.g., a hard drive and/or solid state memory) and may store one or more applications, modules, and/or models such as the NFT engine 106a.

In general, a computer program or computer based product, application, or code (e.g., the model(s), such as AI/ML models, or other computing instructions described herein) may be stored on a computer usable storage medium, or tangible, non-transitory computer-readable medium (e.g., standard random access memory (RAM), an optical disc, a universal serial bus (USB) drive, or the like) having such computer-readable program code or computer instructions embodied therein, wherein the computer-readable program code or computer instructions may be installed on or otherwise adapted to be executed by the processor 104 (e.g., working in connection with the respective operating system in the memory 106) to facilitate, implement, or perform the machine readable instructions, methods, processes, elements or limitations, as illustrated, depicted, or described for the various flowcharts, illustrations, diagrams, figures, and/or other disclosure herein. In this regard, the program code may be implemented in any desired program language, and may be implemented as machine code, assembly code, byte code, interpretable source code or the like (e.g., via Golang, Python, C, C++, C #, Objective-C, Java, Scala, ActionScript, JavaScript, HTML, CSS, XML, etc.).

More generally, the memory 106 may include one or more forms of volatile and/or non-volatile, fixed and/or removable memory, such as read-only memory (ROM), electronic programmable read-only memory (EPROM), random access memory (RAM), erasable electronic programmable read-only memory (EEPROM), and/or other hard drives, flash memory, MicroSD cards, and others. The memory 106 may store an operating system (OS) (e.g., Microsoft Windows, Linux, Unix, etc.) capable of facilitating the functionalities, apps, methods, or other software as discussed herein. The memory 106 may also store an NFT engine 106a, which may be or include AI/ML based models, such as a machine learning model trained on various memory data and/or transaction data, as described herein. Additionally, or alternatively, the NFT engine 106a may also be stored in the external storage device 112, which is accessible or otherwise communicatively coupled to the central hub 102.

The memory 106 may also store machine readable instructions, including any of one or more application(s), one or more software component(s), and/or one or more application programming interfaces (APIs), which may be implemented to facilitate or perform the features, functions, or other disclosure described herein, such as any methods, processes, elements or limitations, as illustrated, depicted, or described for the various flowcharts, illustrations, diagrams, figures, and/or other disclosure herein. For example, at least some of the applications, software components, or APIs may be, include, otherwise be part of, a memory or transactional machine learning model or component, such as the NFT engine 106a, where each may be configured to facilitate their various functionalities discussed herein. It should be appreciated that one or more other applications may be envisioned and that are executed by the processor 104.

In some examples, the memory 106 can include computer program instructions for executing or applying the NFT engine 106a. For example, the instructions can include the NFT engine 106a that is executable by the processor 104 for causing the processor 104 to analyze user data to classify a memory experienced by the user, generate an NFT based on the memory, mint the NFT corresponding to the memory to a blockchain, and/or other suitable actions or combinations thereof. The generation/minting of the NFT may include, for example, generating potential names for the memory, and/or determining which user data to include and/or reference in the NFT for later access.

To illustrate, the NFT engine 106a may output a recommended NFT with a reference name of “Daisy's Birthday Party 2023” or “My First Roller Coaster Ride.” The NFT engine 106a may further include instructions causing the processor 104 to link or otherwise include curated user data associated with the memory based on the type of memory. For example, the NFT engine 106a may cause the processor 104 to determine that the roller coaster ride corresponded to a significantly higher than average heartbeat/heartrate for the user (e.g., exceeding a heartbeat/heartrate threshold) than a normal event. Thus, the NFT engine 106a may instruct the processor 104 to include such heartbeat/heartrate data in the NFT associated with the roller coaster ride to facilitate a more accurate recreation of the roller coaster ride when the user attempts to relive the memory.

Similarly, the NFT engine 106a may cause the processor 104 to determine that the birthday party corresponded to a significantly higher than average number of photos or video including the user (e.g., exceeding an image/video threshold) than a normal event. Accordingly, the NFT engine 106a may instruct the processor 104 to include such image/video data in the NFT associated with the birthday party to facilitate a more accurate recreation of the birthday party when the user attempts to relive the memory and may include image/video/audio data in the NFT associated with the birthday party.

More specifically, in certain embodiments, the processor 104 may utilize one or more machine learning (ML) techniques to train the NFT engine 106a, or a portion thereof, as a ML model. The NFT engine 106a may be trained using a training dataset that includes a plurality of memory data, such as sensor data from the one or more sensors 118, data retrieved from one or more external sources (e.g., external computing device 116, social media platform(s), etc.). The NFT engine 106a may use the training dataset to output, for each memory for which the NFT engine 106a receives memory data as an input, a recommended data set from the memory data to include in the minting transaction for inclusion in/reference by the NFT, recommended NFT listing title/description, and/or other suitable values or combinations thereof.

Generally speaking, ML techniques have been developed that allow parametric or nonparametric statistical analysis of large quantities of data. Such ML techniques may be used to automatically identify relevant variables (i.e., variables having statistical significance or a sufficient degree of explanatory power) from data sets. This may include identifying relevant variables or estimating the effect of such variables that indicate actual observations in the data set. This may also include identifying latent variables not directly observed in the data, such as variables inferred from the observed data points. More specifically, a processor or a processing element may be trained using supervised or unsupervised ML.

In supervised machine learning, a machine learning program operating on a server, computing device, or otherwise processors, may be provided with example inputs (e.g., “features”) and their associated, or observed, outputs (e.g., “labels”) in order for the machine learning program or algorithm to determine or discover rules, relationships, patterns, or otherwise machine learning “models” that map such inputs (e.g., “features”) to the outputs (e.g., labels), for example, by determining and/or assigning weights or other metrics to the model across its various feature categories. Such rules, relationships, or otherwise models may then be provided subsequent inputs in order for the model, executing on a server, computing device, or otherwise processors as described herein, to predict or classify, based upon the discovered rules, relationships, or model, an expected output, score, or value.

In unsupervised machine learning, the server, computing device, or otherwise processors, may be required to find its own structure in unlabeled example inputs, where, for example multiple training iterations are executed by the server, computing device, or otherwise processors to train multiple generations of models until a satisfactory model, e.g., a model that provides sufficient prediction accuracy when given test level or production level data or inputs, is generated.

Example ML programs/algorithms that may be utilized by the processor 104 to train the NFT engine 106a may include, without limitation: neural networks (NN) (e.g., convolutional neural networks (CNN), deep learning neural networks (DNN), combined learning module or program), linear regression, logistic regression, decision trees, support vector machines (SVM), naïve Bayes algorithms, k-nearest neighbor (KNN) algorithms, random forest algorithms, gradient boosting algorithms, Bayesian program learning (BPL), voice recognition and synthesis algorithms, image or object recognition, optical character recognition (OCR), natural language understanding (NLU), and/or other ML programs/algorithms either individually or in combination.

After training, ML programs (or information generated by such ML programs) may be used to evaluate additional data. Such data may be and/or may be related to memory data of particular memories that was not included in the training dataset. The trained ML programs (or programs utilizing models, parameters, or other data produced through the training process) may accordingly be used for determining, assessing, analyzing, predicting, estimating, evaluating, or otherwise processing new data not included in the training dataset. Such trained ML programs may, therefore, be used to perform part or all of the analytical functions of the methods described elsewhere herein.

It is to be understood that supervised ML and/or unsupervised ML may also comprise retraining, relearning, or otherwise updating models with new, or different, information, which may include information received, ingested, generated, or otherwise used over time. The disclosures herein may use one or more of such supervised and/or unsupervised ML techniques. Further, it should be appreciated that, as previously mentioned, the NFT engine 106a may be used to output memory datasets for inclusion and/or reference by the NFT, recommended NFT listing titles/descriptions, and/or other suitable values or combinations thereof, using artificial intelligence (e.g., a ML model of the NFT engine 106a) or, in alternative aspects, without using artificial intelligence.

Moreover, although the methods described elsewhere herein may not directly mention ML techniques, such methods may be read to include such ML for any determination or processing of data that may be accomplished using such techniques. In some aspects, such ML techniques may be implemented automatically upon occurrence of certain events or upon certain conditions being met. In any event, use of ML techniques, as described herein, may begin with training a ML program, or such techniques may begin with a previously trained ML program.

In any event, the memory 106 may also include a copy of a distributed ledger 106b. Namely, the memory 106 may store a copy of a distributed ledger 106b that is distributed and/or otherwise stored on various other computing systems (e.g., other nodes). The copy of the distributed ledger 106b stored in the memory 106 may include transaction records corresponding to multiple different users and multiple different memories. For example, the distributed ledger 106b may include transaction records corresponding to a first user selling and/or otherwise minting a first memory (e.g., a promotion), transferring a second memory (e.g., the first user's child's first day of school) to a child of the first user, and minting a third memory (e.g., retirement account reaching $100,000 for the first time). Similarly, the distributed ledger 106b may include transaction records corresponding to a second user minting a fourth memory (e.g., buying a first vehicle).

Therefore, as the memory 106 stores a copy of the distributed ledger 106b, the computing system 100 may contribute and/or otherwise participate in updating and/or validating additional entries or changes to the distributed ledger 106b by achieving consensus with the other nodes (not shown) that include a copy of the distributed ledger 106b. Further, the distributed ledger 106b may also include the consensus rules and/or other instructions required for the computing system 100 to perform the calculations necessary to validate new additions and/or changes to entries in the ledger 106b. The computing system 100 may communicate with the other connected nodes that participate in the validation/consensus process for the distributed ledger 106b through the networking interface 108.

In particular, the computing system 100 includes a networking interface 108 to connect with external devices, such as the additional nodes that contribute and/or otherwise participate in the updating/changing of entries in the distributed ledger 106b through the consensus process. More specifically, the networking interface 108 may enable the computing system 100 to communicate with other computing systems (e.g., additional nodes) across a network through their respective networking interfaces 108. The networking interface 108 may support wired or wireless communications, such as USB, Bluetooth, Wi-Fi Direct, Near Field Communication (NFC), etc. The networking interface 108 may allow the computing system 100 to communicate with other computing systems via a wireless communication network such as a fifth-, fourth-, or third-generation cellular network (5G, 4G, or 3G, respectively), a Wi-Fi network (802.11 standards), a WiMAX network, a wide area network (WAN), a local area network (LAN), etc.

The computing system 100 may also provide a display 110, an input device 114, and/or other I/O components (e.g., ports, capacitive or resistive touch sensitive input panels, keys, buttons, lights, LEDs), which may be directly accessible via or attached to the computing system 100 or may be indirectly accessible. According to some embodiments, a user may access the computing system 100 via the input device 114 to review information, make changes, input training data or images, and/or perform other functions.

For example, and to provide for interaction with an individual, the herein disclosed embodiments may be implemented using the display 110, such as a user interface. Such user interfaces may include interactive features such as pop-up or pull-down menus, lists, selection tabs, checkboxes, radio buttons, toggles, sliders, buttons, hyperlinks and/or other features or user interface widgets that can receive human inputs. The display 110 may also include one or more of a number of output mechanisms, such as a display screen, a printer, a speaker, a heads-up display, an AR display, a VR headset, or any other output or display mechanism.

Further, to enable human (and in some instances, machine) user interaction, the computing system 100 may include an input device 114. The input device 114 may be or include, for example, a microphone for speech and audio, a touch sensitive screen for gesture or graphical input, keyboard, mouse, motion input, motion detection, camera for video and photo input, virtual reality gloves, controllers, thumb rings, wands, move controllers, touch controllers, knuckle controllers, glasses with eye controllers, and the like. In some instances, multimodal input devices 114 may enable a user to provide multiple types of input to communicate with the computing system 100.

In certain embodiments, the computing system 100 may also include clients and servers, in a host server configuration. A client and server may generally be remote from each other and may typically interact through a communications network. The relationship of client and server arises by virtue of computer programs running on the respective computers and having a client-server relationship to each other. In some examples, a server transmits data (e.g., an HTML page, data tagged by XML, JSON objects, etc.) to a client device (e.g., for purposes of displaying data to and receiving input from a user interacting with the client device). Data generated at the client device (e.g., as a result of user interaction) can be received from the client device at the server.

More specifically, the computing system 100 may act as a hosting server, and may include a networking interface 108 configured to communicate (e.g., send and receive) data via one or more external/network port(s) to one or more networks or local terminals, as described herein. In some embodiments, the computing system 100 may include a client-server platform technology such as ASP.NET, Java J2EE, Ruby on Rails, Node.js, a web service or online API, responsive for receiving and responding to electronic requests. The computing system 100 may implement the client-server platform technology that may interact, via a computer bus, with the memory 106 (including the applications(s), component(s), API(s), data, etc. stored therein) and/or external storage device 112 to implement or perform the machine readable instructions, methods, processes, elements or limitations, as illustrated, depicted, or described for the various flowcharts, illustrations, diagrams, figures, and/or other disclosure herein. According to some embodiments, the computing system 100 may include, or interact with, one or more transceivers (e.g., WWAN, WLAN, and/or WPAN transceivers) functioning in accordance with IEEE standards, 3GPP standards, or other standards, and that may be used in receipt and transmission of data via external/network ports connected to a computer network. In some embodiments, the computer network may comprise a private network or local area network (LAN). Additionally, or alternatively, the computer network may comprise a public network such as the Internet.

Further, the computing system 100 may include a sensory feedback system 120 that is configured to provide sensory feedback to a user while the user is reliving a memory that is stored and/or otherwise referenced by an NFT recorded on the distributed ledger 106b. The sensory feedback system may generally provide a user with visual feedback, audio feedback, haptic feedback, olfactory feedback, temperature feedback, and/or any other suitable type or degree of sensory feedback, such that the recreated memory approaches the original conditions of the memory. Accordingly, the sensory feedback system 120 may be or include a VR/AR headset and/or other audio/visual feedback components (e.g., headphones/speakers, display interface), haptic feedback components (e.g., vibration mechanisms), temperature feedback components (e.g., heating/cooling pads), olfactory feedback components (e.g., bottled scents), and/or other suitable feedback components or combinations thereof.

For example, the NFT engine 106a may cause the processor 104 to access the data linked to the NFT and display, via the sensory feedback system 120, a recreation of the memory for the user based on the data. As such, the NFT engine 106a may further cause the processor 104 to cause the sensory feedback system 120 to provide sensory feedback to the user in conjunction with the recreation of the memory. For example, a user may want to relive a memory of ice skating in Rockefeller Plaza, and the NFT engine 106a may cause the processor 104 to cause the sensory feedback system 120 to display video data of the user ice skating, images of that memory, audio recordings of the memory, and may recreate the known temperature conditions and/or scents the user experienced while ice skating.

FIG. 1B is a block diagram illustrating an example NFT engine 106a of FIG. 1A, in accordance with various embodiments herein. Broadly, the example NFT engine 106a may be configured to analyze user data to classify a memory experienced by the user, generate an NFT based on the memory, mint the NFT corresponding to the memory to a blockchain, and/or other suitable actions or combinations thereof. The NFT engine 106a generally includes a non-fungible engine 1000, an experience NFTs component 2000, and a memory NFTs component 3000.

The non-fungible engine 1000 may be a robust, secure foundational layer that orchestrates a personalized, immersive environment where users can create, manage, and engage with their digital assets (memories) and communities. The non-fungible engine 1000 establishes decentralized digital identities for each user and powers real-time intelligent interactions, thereby allowing users to seamlessly preserve and engage with their memories. The non-fungible engine 1000 includes a data collection component 1100, a decentralized identity creation (DID) component 1200, an AI-driven lifelogging component 1300, and a context-aware NFT component 1400.

The data collection component 1100 performs multi-source data collection from, for example, social media, IoT devices, wearables, and external databases. This provides a holistic view of user preferences, habits, and lives while adhering to strict privacy regulations and informed consent. The data collection component 1100 may utilize AI-driven analytics to identify patterns and trends that inform features of the NFT engine 106a. Accordingly, the data collection component 1100 ensures memories/experiences are tailored to each user's unique life story. The data collection component 1100 may also include predictive models configured to forecast future interests and health factors to keep the NFT engine 106a engaging and relevant for users. The data collection component 1100 may also allow customizable data visualization for easy user digestion and interaction, giving users control over the design and content of their memories.

At a high level, the data collection component 1100 may be or include ML models, such as recurrent neural networks to analyze speech, text, and/or facial expressions to detect emotions. The data collection component 1100 may also employ robust data security and privacy standards enforcement through secure encryption methods/techniques and may facilitate and/or otherwise orchestrate API integration with various data sources (e.g., external websites, plugins, etc.) enabling a holistic view of each user's life and memories.

The DID component 1200 may create decentralized digital identities (DIDs) for each user to serve as the foundation for use onboarding onto the NFT engine 106a. By moving identity management away from centralized providers, users gain full ownership and control over their digital identities and personal data. This self-sovereign approach facilitated by the DID component 1200 enhances privacy, security, and portability of identities across the NFT engine's 106a features and services. The DID component 1200 may utilize selective disclosures and zero-knowledge proofs (ZKPs) to minimize unnecessary data sharing, and may otherwise enable users to have granular control over their data. Moreover, the DID component 1200 leverages distributed ledger (e.g., blockchain) based IDs and data permissions to minimize the need for raw data sharing while preserving compliance requirements.

The DID component 1200 may comply with the W3C DID specification to enable globally unique persistent identifiers and verifiable decentralized digital identity. Further, the DID component 1200 enables interoperability with different networks by defining specific implementations of DIDs anchored to different networks like blockchain or web-based networks. The DID component 1200 may also manage DID documents containing metadata associated with a DID, such as public keys, end points, verification methods, and may create portable identities. The DID component 1200 may utilize DID resolvers to fetch current DID documents, may manage verifiable credentials, may leverage DIDComm to provide secure encrypted communications, and may validate transactions without reveling sensitive data through ZKPs.

The AI-driven lifelogging component 1300 may generally capture users' unique life events and daily activities. By integrating data from sources like social media, fitness trackers, and smart home devices, the AI-driven lifelogging component 1300 may create a holistic digital chronicle of a user's life journey. As mentioned, the AI-driven lifelogging component 1300 may utilize multi-source data integration to aggregate data from diverse sources like fitness trackers and smart home devices and may execute AI/ML algorithms to continuously analyze this data and identify patterns, milestones, and preferences to enhance predictive recommendations.

Life logging may generally involve extensive data collection, such that a user's privacy is paramount. The AI-driven lifelogging component 1300 may leverage techniques like federated learning and differential privacy to address these privacy concerns. Moreover, the AI-driven lifelogging component 1300 utilizes various routines to contextualize/understand a user's memories/experiences. Namely, the AI-driven lifelogging component 1300 may use contextual event detection to distinguish routine activities from significant occurrences using contextual data analysis. For example, the AI-driven lifelogging component 1300 may manage and/or otherwise evaluate whether individual events satisfy the various thresholds necessary to qualify as a significant memory/experience.

The AI-driven lifelogging component 1300 may generally include activity tracking APIs to enable the NFT engine 106a to integrate with various tracking apps and devices. For example, the AI-driven lifelogging component 1300 may include APIs to integrate with health tracking applications connected with a smartwatch, smart ring, etc. and/or to otherwise collect fitness and movement data. Additionally, the AI-driven lifelogging component 1300 may include a variety of social media APIs to help extract key events, interests, relationships, etc. from social media platforms. The AI-driven lifelogging component 1300 may also include natural language processing (NLP) models to extract semantic insights and temporal relationships from unstructured data captured by sensors and transmitted to the NFT engine 106a through APIs included as part of the AI-driven lifelogging component 1300. The AI-driven lifelogging component 1300 may also include knowledge graphs that map real-world entities and relationships between digital artifacts (e.g., memories/experiences).

The context-aware NFT component 1400 creates context-aware NFTs by integrating sensory and emotional imprints gathered by the AI-driven lifelogging component 1300, and/or may transmit such data to the experience NFTs component 2000 and/or the memory NFTs component 3000 to create such NFTs. The AI/ML models included as part of the context-aware NFT component 1400 may recognize significant events by determining whether each individual event satisfies a memory threshold, and may mint unique NFTs embedding the memory and associated data for multidimensional reliving. More specifically, the AI algorithms of the context-aware NFT component 1400 may analyze lifelogging data (e.g., memory data) to identify meaningful moments and associated feelings, which may trigger automated minting of NFTs that embed relevant context. The context-aware NFT component 1400 may mint NFTs that include time data, biometric data, sensory data, and emotional data to comprehensively capture the memory while preserving privacy. The context-aware NFT component 1400 may also include customizable templates that enable users to customize NFT designs to match their style and the specific memory. The context-aware NFT component 1400 may also host and/or otherwise enable access to interactive galleries where users may visit NFTs and share memories with others. The context-aware NFT component 1400 may also include legacy provisions to help users control inheritor access permissions for specific memories.

The context-aware NFT component 1400 may include ML models like recurrent neural networks and/or others to analyze speech, text, facial expression(s), etc. to detect emotions. The context-aware NFT component 1400 may also utilize supervised learning classifiers to categorize events (e.g., memories) and classify the significance of such events, and may adhere to schema standards like ERC-721 and DID-Metadata to encode context into the NFTs. The context-aware NFT component 1400 may leverage edge computing for quick, private processing of emotional and biometric data, may utilize the InterPlanetary File System (IPFS) to store NFT multimedia data/content off-chain, and may manage the smart contracts with controls to manage access by inheritors and/or others that may transact with the user.

Generally speaking, the experience NFTs component 2000 includes a set of NFTs meant to immortalize singular experiences within a user's life that may define a significant transition and/or other important moment(s). More specifically, the experience NFTs component 2000 may store data from biometric sensors (e.g., one or more sensors 118) to capture a user's unique emotional state, heartbeat, brainwaves, etc. as they experience milestone events, such as a work farewell speech, post-retirement trip, engagement, wedding, etc. The experience NFTs component 2000 may integrate these data points into NFTs that recreate the sensory feeling and impact of such significant experiences. The experience NFTs component 2000 may include a biometric data component 2100, an emotional context component 2200, and an AR/VR environment 2300.

The biometric data component 2100 may include instructions to capture biometric data during experiences including any accompanying emotions through physiological signals, and may integrate this data in real-time into an NFT to capture the user's emotional state. The biometric data component 2100 may interface, for example, with the AI-driven lifelogging component 1300 to access the APIs necessary to acquire and integrate wearables data and/or other sensor data that may correspond to the user's experience(s). The biometric data component 2100 may also utilize AI/ML algorithms to map biometric signals to emotional contexts, and thereby tag experiences for later recreation/reliving by the user.

As part of these AI/ML algorithms, the biometric data component 2100 may also utilize generated emotional contexts to enrich the experience NFTs. Namely, the biometric data component 2100 may enrich the data associated with the experience by generating, by a contextual memory detection algorithm, a contextual narrative configured to explain a backstory of the experience, a character included in the experience (e.g., a friend, family member, co-worker), an emotional response of the user during the experience, and/or any other suitable narrative or combinations thereof. The biometric data component 2100 may also layer, into the data, a photo, a video, an audio track, a text sequence, and/or a generated emotional context corresponding to the experience that was not included in the data.

The emotional context component 2200 may build on the context provided by the biometric data component 2100 to enrich/enhance stored experiences with comprehensive emotional context including ambient nuances, such as scents and temperatures. In particular, the emotional context component 2200 may include diverse sensorial data (e.g., image/video, audio, temperature, scents, etc.) to capture most/all sensorial aspects of a particular experience (e.g., tangible elements like stadium rumblings, live music etc.). The emotional context component 2200 may take this sensorial data and the data acquired through additional data sources (e.g., social media) to develop emotional context that may be conveyed to a user in tandem with the sensorial data to holistically recreate the environmental and emotional conditions during recollection to enhance the experience for the user.

The AR/VR environment 2300 may generally enable users to step back into their experiences in an interactive, multi-dimensional format. The AR/VR environment 2300 may interact with AR/VR headsets connected to the NFT engine 106a to display experiences for users that may be explorable in lifelike, three-dimensional (3D) detail. As part of this exploration, the AR/VR environment 2300 may be enable users to interact and personalize their experiences, such as by selecting perspectives and areas to focus within the experience. The AR/VR environment 2300 may also allow users to socialize within their experiences/memories by inviting others into their experiences/memories. Further, the AR/VR environment 2300 may facilitate customizable avatars, environments, and privacy controls that users may leverage within the virtual environment.

The memory NFTs component 3000 may perform similar functions as the experience NFTs component 2000 for memories by leveraging AI/ML to identify meaningful memories and encoding them into NFTs. The memory NFTs component 300 may include a memories component 3100, a memory enhancement component 3200, and a reliving memories component 3300.

The memories component 3100 curates user memories by using AI/ML algorithms configured to receive user input (e.g., user indications of impact, emotional context, etc.) and sensor data and to distinguish the most significant memories for immortalization as NFTs. Namely, the memories component 3100 AI algorithms may determine an emotional impact of a particular memory based on the user input and sensor data, and may also evaluate how often certain memories are re-lived, discussed, and/or otherwise relevant to the user currently to recommend most important memories and/or what future memories should be turned into NFTs. For example, the AI algorithm may analyze prior memories/experiences to determine qualities of those that are most popular with the user and/or others with access to the memories/experiences and may generate NFT recommendations for current events in a user's life that have qualities (e.g., sensor data, context data) similar to the popular memories/experiences.

The memory enhancement component 3200 may enhance memories with multimedia and backstories to enrich/enhance static recollections provided by, for example, image data into vivid, multidimensional experiences. Similar to the biometric data component 2100 and the emotional context component 2200, the memory enhancement component 3200 may enrich the data associated with a memory by generating, by a contextual memory detection algorithm, a contextual narrative configured to explain a backstory of the memory, a character included in the memory (e.g., a friend, family member, co-worker), an emotional response of the user during the memory, and/or any other suitable narrative or combinations thereof. The memory enhancement component 3200 may also layer, into the data, a photo, a video, an audio track, a text sequence, and/or a generated emotional context corresponding to the experience that was not included in the data.

The reliving memories component 3300 may facilitate users recreating and reliving memories stored as NFTs by the NFT engine 106a through virtual experiences (e.g., via AR/VR devices). Similar to the AR/VR environment 2300, the reliving memories component 3300 may allow users to explore and re-experience their memories from new angles and modalities with sensory feedback systems, such as haptics and olfaction, for added realism and immersion. The reliving memories component 3300 may also allow users to socialize within their experiences/memories by inviting others into their experiences/memories. Further, the reliving memories component 3300 may enable users to provide and/or otherwise influence the evolution of the memories over time by appending new insights input by the user and/or determined by AI/ML algorithms of the reliving memories component 3300 that analyze lifelogging data from a variety of sources.

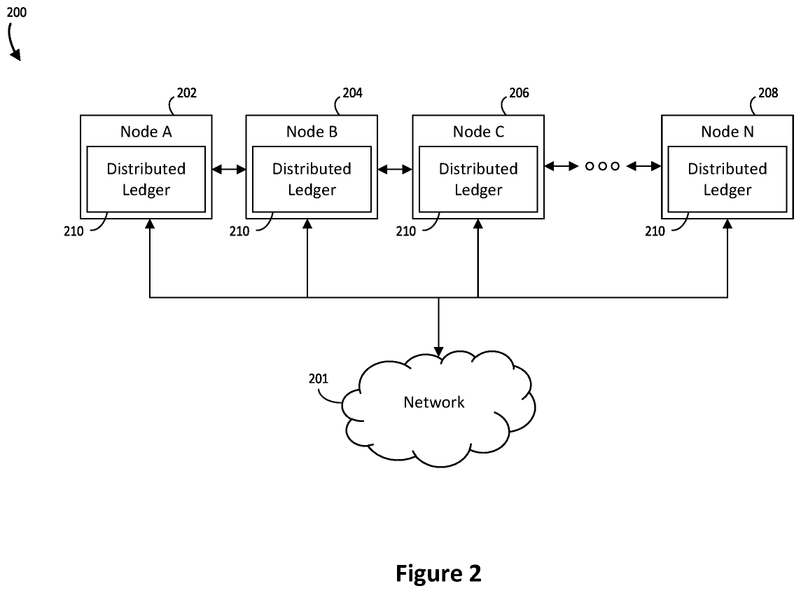

FIG. 2 depicts an example distributed ledger system 200 for recording memory information. The distributed ledger system 200 includes a distributed ledger 210 and a plurality of nodes 202, 204, 206, and 208. Each node 202-208 may maintain a copy of the distributed ledger 210. As illustrated, N may be any integer value, such that there may be any suitable number of nodes 202-208 that maintain a copy of the distributed ledger 210. The N number of nodes 202-208 may also each be included as part of the consensus mechanism/method used to update/change the distributed ledger 210.

As previously mentioned, as changes are made to the distributed ledger 210, each node 202-208 receives the change via the network 201 and updates its respective copy of the distributed ledger 210. A consensus mechanism may be used by the nodes 202-208 in the distributed ledger system 200 to decide whether it is appropriate to make received changes to the distributed ledger 210. For example, the consensus mechanism may be the Stellar Consensus Protocol (SCP), a variant of Practical Byzantine Fault Tolerance (PBFT), where nodes 202-208 belonging to intersecting groups run a local consensus protocol among their members, providing a method that is decentralized and open to the public. As a result of this consensus method, every intersecting group may participate in the consensus protocol with very low transaction latency. Of course, it should be understood that any suitable consensus mechanism/method or combinations thereof may be used.

Therefore, by maintaining a consensus among the nodes 202-208 to authorize any/all updates/changes to the distributed ledger 210, each node 202-208 in the distributed ledger system 200 may have an identical copy of the distributed ledger 210 to every other copy of the distributed ledger 210 stored by the other nodes 202-208. Accordingly, the distributed ledger system 200 may be more robust than a central authority database system because of the decentralized nature of the distributed ledger 210, such that there is no single point of failure in the distributed ledger system 200 as there is in conventional centralized systems.

To illustrate, Node A 202 may receive a transaction listing from a user indicative of an action corresponding to a new memory or experience, an NFT corresponding to the memory/experience, and/or any other suitable data or combinations thereof. Node A 202 may generate a transaction representing and/or otherwise based upon the transaction listing and may tentatively upload the transaction to the distributed ledger 210. This uploaded transaction may be transmitted to each of the connected nodes 204-208, where each connected node 204-208 independently performs the calculations necessary to validate the authenticity of the transaction for recordation in the distributed ledger 210. Upon reaching a consensus among all nodes 202-208, the transaction corresponding to the vehicle may be officially recorded in the distributed ledger 210 and represented in all copies of the distributed ledger 210 in all connected nodes 202-208.

### Example Transaction Recordation of a Memory in a Distributed Ledger

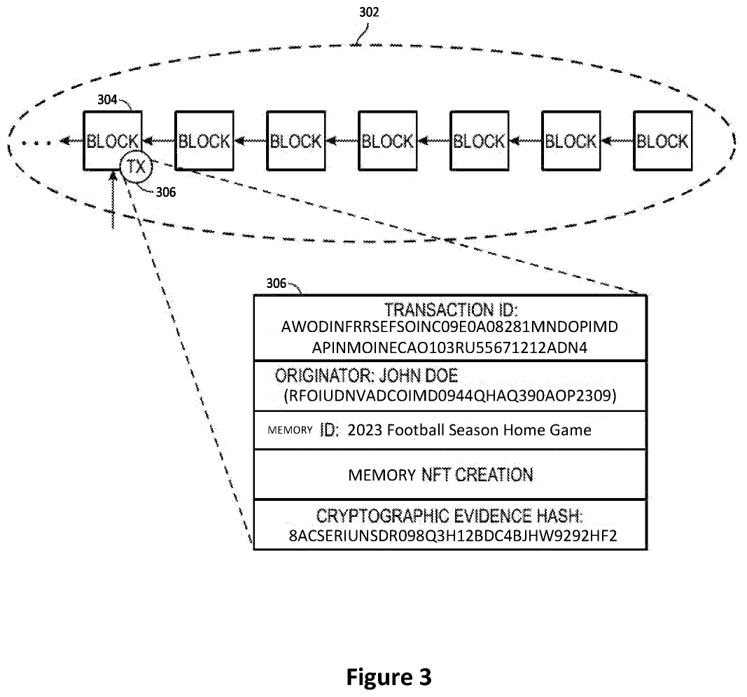

FIG. 3 illustrates an example transaction 306 recording identification information for a memory in a distributed ledger 302 of the distributed ledger 210 illustrated in FIG. 2. The transaction 306 may include a transaction ID and an originator such as John Doe who is the creator or original owner of the memory (identified by a cryptographic proof-of-identity). The transaction 306 may also include identification information for the memory, such as a description of the memory (2023 Football Season Home Game) and/or a unique identification number for the memory, such as an NFT. Of course, it should be appreciated that the transaction 306 may include and/or otherwise reference any suitable information corresponding to the memory and/or the user/entity listing the transaction.

In some embodiments, the transaction 306 may mint an NFT representing the memory which includes properties of the memory, such as the identification information. The NFT may be recorded in the distributed ledger 302 and may thereby be available for reference as part of the listed transaction. In certain embodiments, an NFT representing the memory may be obtained from an external system. The transaction may then record the obtained NFT in the distributed ledger 302.

Furthermore, the transaction 306 may include a cryptographic hash of the identification information. For example, the transaction 306 illustrated in FIG. 3 includes a cryptographic evidence hash that is stored in the distributed ledger 302 as part of the transaction 306. In some embodiments, the identification information may not be stored as a cryptographic hash but may be directly accessible in block 304 by an observer or other network participant.

To facilitate the transfer of memories/experiences and ensure transparency in transactions involving these memories, the nodes (e.g., Node A 202, Node B 204) that participate in the validation/consensus mechanism for a distributed ledger (e.g., distributed ledger 302) may generate and display user interfaces on client devices of users. A client device may be a smart phone, a tablet, a laptop computer, a desktop computer, a wearable device such as a smart watch or smart glasses, etc. The client devices may communicate directly with a distributed ledger, such as the distributed ledger 302 as shown in FIG. 3. In other embodiments, a server device may connect to and/or otherwise monitor the distributed ledger 302, obtain transaction information from the distributed ledger 302, and may provide the transaction information to a client device for display to the user. Therefore, in certain embodiments, the client device may be a node connecting directly to the distributed ledger 302, and in other embodiments, the client device may connect to a node that is connected to the distributed ledger 302.

### Example Virtual Representations of Memories Stored in a Distributed Ledger

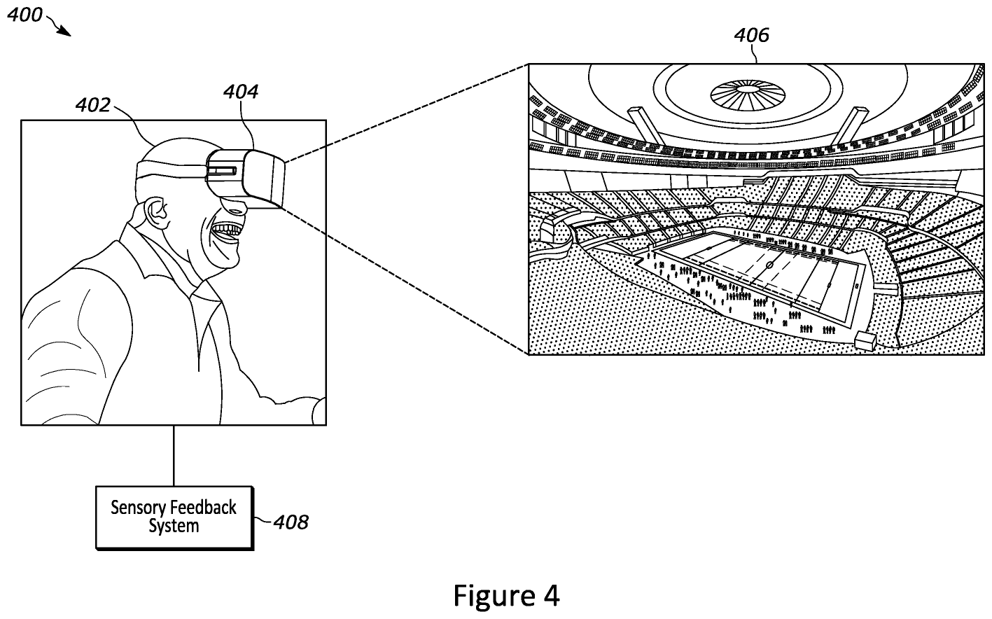

FIG. 4 depicts a user 402 viewing a recreated memory 406 in a virtual environment 400, in accordance with various embodiments herein. In particular, the recreated memory 406 may be a virtual, three-dimensional model of the user's 402 memory facilitated by the VR headset 404 the user 402 is wearing.

In the virtual environment 400, the user 402 may have experienced a football game in a stadium, as illustrated in the recreated memory 406. In particular, the user 402 may have experienced the football game years ago, and may have created an NFT storing much of the sensory information and other contextual information related to the football game, as described herein. The user 402 may be utilizing the VR headset 404 and the sensory feedback system 408 to recreate and relive the football game in the present time. Thus, the user 402 may access their memory through the NFT and related data stored on the distributed ledger, and the VR headset 404, sensory feedback system 408, and/or other components described herein may generate a virtual, 3D model of the user's 402 memory in the stadium during the football game.

In this example illustrated in FIG. 4, the user 402 may view 3D images and/or video of the interior of the stadium during the football game they attended, from the seat they sat in during the game. The systems described herein may further augment the visual data with any other data corresponding to the memory to enhance the recreation. For example, the system may include audio data recorded during the game into the recreated memory 406 to simulate a particular play or event during the game, and the sensory feedback system 408 may provide haptic feedback to simulate the vibrations of the stadium, make audio data more impactful, and generally increase the overall realism of the recreated memory 406. Further, the sensory feedback system 408 may provide scents that mimic the interior smell/ambiance of the stadium, and/or may adjust the temperature of pads or other devices impacting the user 402 to recreate similar environmental conditions as were present during the actual football game.

While the user 402 is experiencing the recreated memory 406, the systems described herein may enable the user 402 to interact with the recreation to further improve the user's 402 engagement. For example, the user 402 may interact with the VR headset 404 to adjust the user's 402 viewpoint from within the recreation of the user's 402 seat within the stadium. The user 402 may tilt their head left, right, up, down, etc., and may view different portions of the stadium interior in accordance with the direction the user 402 moved their head.

Additionally, the systems described herein may augment and/or enrich the recreated memory 406 in any suitable manner based on data retrieved from any suitable source. For example, the NFT engine (e.g., NFT engine 106a) may augment the recreated memory 406 by overlaying a broadcast of a particular play or moment within the game represented by the recreated memory 406.

### Example Method for Preserving Memories and Experiences Through an NFT Engine

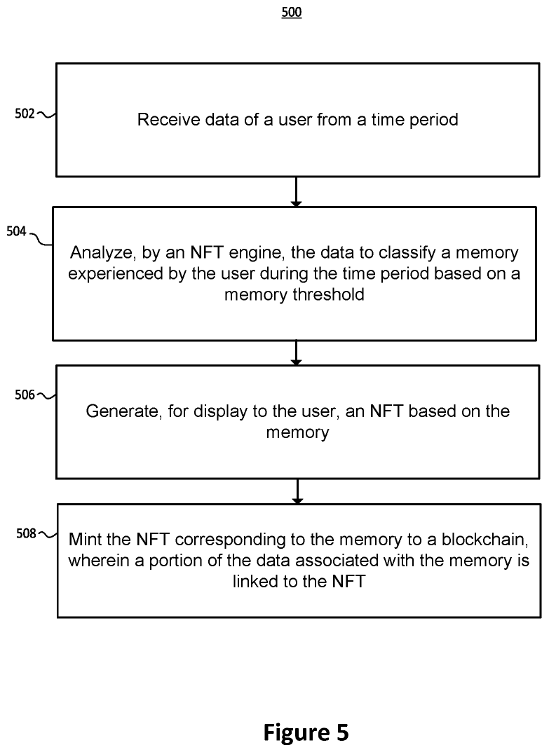

FIG. 5 is a block diagram of an example computer-implemented method 500 for preserving memories and experiences through an NFT engine, in accordance with various embodiments herein. Generally speaking, any of the actions described herein in reference to the method 500 may be performed by a node (e.g., nodes 202-208, 302, 304), a server device, and/or any combinations thereof.

At block 502, the method 500 may include receiving data of a user from a time period. The method 500 may further include analyzing, by an NFT engine, the data to classify a memory experienced by the user during the time period based on a memory threshold (block 504). The method 500 may further include generating, for display to the user, an NFT based on the memory (block 506). The method 500 may further include minting the NFT corresponding to the memory to a blockchain (block 508). A portion of the data associated with the memory may be linked to the NFT.

In some embodiments, the time period is a first time period, and the method 500 further includes: accessing, by the one or more processors, the data linked to the NFT during a second time period that is different from the first time period; displaying, via a sensory feedback system, a recreation of the memory for the user based on the data; and causing, by the one or more processors, the sensory feedback system to provide sensory feedback to the user in conjunction with the recreation.

As described herein, the time periods may generally correspond to lengths of time, during which, a user experienced a significant memory/experience. These time periods may vary for each memory/experience. For example, a first memory corresponding to the user enjoying a holiday may span a time period of one or several days, whereas a second memory corresponding to a sporting event may span a time period of only several hours. Moreover, an experience corresponding to a public speech or the user's first stand-up comedy set may only last a few minutes.

In some embodiments, the sensory feedback includes one or more of: (i) visual feedback, (ii) audio feedback, (iii) haptic feedback, or (iv) olfactory feedback.

In some embodiments, the method 500 further includes: capturing, by a plurality of sensors, the data of the user from the time period, wherein the data of the user includes one or more of: (i) heartbeat data, (ii) brainwave data, (iii) emotional context data, (iv) scent data, (v) temperature data, (vi) audio data, (vii) image data, or (viii) video data.

In some embodiments, the method further includes: aggregating, by the one or more processors, the data from a plurality of data sources including one or more of: (i) a wearable device, (ii) a smart home device, (iii) a social media platform, or (iv) a user computing device; and determining, by the one or more processors executing a contextual memory detection algorithm, whether the data satisfies the memory threshold based on a plurality of thresholds associated with the plurality of data sources.

As described herein, the memory threshold may be a single threshold and/or may be comprised of multiple thresholds. For example, the memory threshold for a first user may be based purely on biometric data available through the first user's smartwatch, as that may be the only device providing data for the NFT engine 106a for the first user. Accordingly, the memory threshold for the first user may comprise thresholds related the user's heartbeat/heart rate (e.g., beats per minute (BPM)), the user's activity (e.g., number of steps), and/or any other suitable data captured by the smartwatch. The first user's heart rate (e.g., 135 BPM) may exceed a heart rate threshold (e.g., 100 BPM), and as a result, the NFT engine 106a may determine that the first user is engaging in some form of activity that is highly unusual for the first user, and the NFT engine 106a may determine that the first user has experienced a memory that should be commemorated with an NFT.

As another example, a second user may have several devices connected to the NFT engine 106a, such that the NFT engine 106a has access to a significant amount of data related to the second user. The NFT engine 106a may then utilize, apply, and/or otherwise consider multiple thresholds for the second user, such as a biometric data threshold (e.g., for heart rate, activity, etc.), an audio/visual threshold (e.g., amount of audio data commenting about the memory, amount of video/image data memorializing the memory), a social media threshold (e.g., number of posts amount a memory), a similarity threshold (e.g., degree of similarity to other memories), an overall threshold (e.g., number of thresholds satisfied), and/or any other suitable type of threshold or combinations thereof.

Thus, in this circumstance, the NFT engine 106a may determine whether a particular event involving the user was a significant memory based on a variety of thresholds that may likely improve the resulting recommendation from the NFT engine 106a. For example, if only the biometric threshold is satisfied (e.g., the second user's heart rate briefly exceeded 100 BPM), then the NFT engine 106a may not likely conclude that the second user experienced a significant memory. However, if the NFT engine 106a determines that all thresholds (e.g., biometric, audio/visual, social media, similarity, overall, etc.) are satisfied, the NFT engine 106a may determine that the second user has experienced a highly unusual event that the user may want to memorialize as an NFT.

Further, as part of this determination regarding whether a particular event experienced by a user is significant enough to be memorialized as an NFT, the NFT engine 106a may leverage an AI/ML model trained to output a classification value corresponding to any particular event. The AI/ML model may be trained with user data as inputs to output training classification values, and these classification values may be or include confidence intervals, numeric scores, categories (e.g., significant, insignificant), and/or any other suitable output or combinations thereof.

In some embodiments, the method 500 further includes: enriching, by the one or more processors, the data associated with the memory by: layering, into the data from at least one of the plurality of data sources, one or more of: (i) a photo, (ii) a video, (iii) an audio track, or (iv) a text sequence corresponding to the memory that was not included in the data, or generating, by the one or more processors executing the contextual memory detection algorithm, a contextual narrative configured to explain one or more of: (i) a backstory, (ii) a character, (iii) an emotion.

In some embodiments, the method 500 further includes: determining, by the one or more processors, an experience within the memory based on the data satisfying the memory threshold and an experience threshold that is different from the memory threshold; generating, by the one or more processors and for display to the user, a second NFT based on the experience; and minting, by the one or more processors, the second NFT corresponding to the experience to the blockchain, wherein a second portion of the data associated with the memory is linked to the second NFT.

In some embodiments, the method 500 further includes receiving, from the user, an approval indication or a rejection indication corresponding to the NFT; responsive to receiving the rejection indication, prompting the user to provide supplemental data corresponding to the memory; and generating a second NFT based on the memory and the supplemental data.

Generally speaking, the supplemental data may be or include any of the user inputs or user data described herein. For example, the NFT engine 106a may generate an NFT indicating that a user experienced a substantial fright when riding their first roller coaster. The user may provide a rejection indication to this NFT, and may provide supplemental data indicating that the user's emotional state was, in fact, happy and excited. Accordingly, the NFT engine 106a may generate a second NFT reflecting the user's actual emotional context related to their first roller coaster ride.

### Additional Considerations

Throughout this specification, plural instances may implement components, operations, or structures described as a single instance. Although individual operations of one or more methods are illustrated and described as separate operations, one or more of the individual operations may be performed concurrently, and nothing requires that the operations be performed in the order illustrated. Structures and functionality presented as separate components in example configurations may be implemented as a combined structure or component. Similarly, structures and functionality presented as a single component may be implemented as separate components. These and other variations, modifications, additions, and improvements fall within the scope of the subject matter herein.

The systems and methods described herein are directed to an improvement to computer functionality, and improve the functioning of conventional computers. Additionally, certain embodiments are described herein as including logic or a number of routines, subroutines, applications, or instructions. These may constitute either software (e.g., code embodied on a non-transitory, machine-readable medium) or hardware. In hardware, the routines, etc., are tangible units capable of performing certain operations and may be configured or arranged in a certain manner. In example embodiments, one or more computer systems (e.g., a standalone, client or server computer system) or one or more hardware modules of a computer system (e.g., a processor or a group of processors) may be configured by software (e.g., an application or application portion) as a hardware module that operates to perform certain operations as described herein.

In various embodiments, a hardware module may be implemented mechanically or electronically. For example, a hardware module may comprise dedicated circuitry or logic that is permanently configured (e.g., as a special-purpose processor, such as a field programmable gate array (FPGA) or an application-specific integrated circuit (ASIC)) to perform certain operations. A hardware module may also comprise programmable logic or circuitry (e.g., as encompassed within a general-purpose processor or other programmable processor) that is temporarily configured by software to perform certain operations. It will be appreciated that the decision to implement a hardware module mechanically, in dedicated and permanently configured circuitry, or in temporarily configured circuitry (e.g., configured by software) may be driven by cost and time considerations.

Accordingly, the term “hardware module” should be understood to encompass a tangible entity, be that an entity that is physically constructed, permanently configured (e.g., hardwired), or temporarily configured (e.g., programmed) to operate in a certain manner or to perform certain operations described herein. Considering embodiments in which hardware modules are temporarily configured (e.g., programmed), each of the hardware modules need not be configured or instantiated at any one instance in time. For example, where the hardware modules include a general-purpose processor configured using software, the general-purpose processor may be configured as respective different hardware modules at different times. Software may accordingly configure a processor, for example, to constitute a particular hardware module at one instance of time and to constitute a different hardware module at a different instance of time.

Hardware modules can provide information to, and receive information from, other hardware modules. Accordingly, the described hardware modules may be regarded as being communicatively coupled. Where multiple of such hardware modules exist contemporaneously, communications may be achieved through signal transmission (e.g., over appropriate circuits and buses) that connect the hardware modules. In embodiments in which multiple hardware modules are configured or instantiated at different times, communications between such hardware modules may be achieved, for example, through the storage and retrieval of information in memory structures to which the multiple hardware modules have access. For example, one hardware module may perform an operation and store the output of that operation in a memory device to which it is communicatively coupled. A further hardware module may then, at a later time, access the memory device to retrieve and process the stored output. Hardware modules may also initiate communications with input or output devices, and can operate on a resource (e.g., a collection of information).

The various operations of example methods described herein may be performed, at least partially, by one or more processors that are temporarily configured (e.g., by software) or permanently configured to perform the relevant operations. Whether temporarily or permanently configured, such processors may constitute processor-implemented modules that operate to perform one or more operations or functions. The modules referred to herein may, in some example embodiments, comprise processor-implemented modules.

Similarly, the methods or routines described herein may be at least partially processor-implemented. For example, at least some of the operations of a method may be performed by one or more processors or processor-implemented hardware modules. The performance of certain of the operations may be distributed among the one or more processors, not only residing within a single machine, but deployed across a number of machines. In some example embodiments, the processor or processors may be located in a single location (e.g., within a home environment, an office environment or as a server farm), while in other embodiments the processors may be distributed across a number of locations.

The performance of certain of the operations may be distributed among the one or more processors, not only residing within a single machine, but deployed across a number of machines. In some example embodiments, the one or more processors or processor-implemented modules may be located in a single geographic location (e.g., within a home environment, an office environment, or a server farm). In other example embodiments, the one or more processors or processor-implemented modules may be distributed across a number of geographic locations.

It should also be understood that, unless a term is expressly defined in this patent using the sentence “As used herein, the term ‘______’ is hereby defined to mean . . . ” or a similar sentence, there is no intent to limit the meaning of that term, either expressly or by implication, beyond its plain or ordinary meaning, and such term should not be interpreted to be limited in scope based upon any statement made in any section of this patent (other than the language of the claims). To the extent that any term recited in the claims at the end of this disclosure is referred to in this disclosure in a manner consistent with a single meaning, that is done for sake of clarity only so as to not confuse the reader, and it is not intended that such claim term be limited, by implication or otherwise, to that single meaning.

Unless specifically stated otherwise, discussions herein using words such as “processing,” “computing,” “calculating,” “determining,” “presenting,” “displaying,” or the like may refer to actions or processes of a machine (e.g., a computer) that manipulates or transforms data represented as physical (e.g., electronic, magnetic, or optical) quantities within one or more memories (e.g., volatile memory, non-volatile memory, or a combination thereof), registers, or other machine components that receive, store, transmit, or display information.

As used herein any reference to “one embodiment” or “an embodiment” means that a particular element, feature, structure, or characteristic described in connection with the embodiment is included in at least one embodiment. The appearances of the phrase “in one embodiment” in various places in the specification are not necessarily all referring to the same embodiment.

Some embodiments may be described using the expression “coupled” and “connected” along with their derivatives. For example, some embodiments may be described using the term “coupled” to indicate that two or more elements are in direct physical or electrical contact. The term “coupled,” however, may also mean that two or more elements are not in direct contact with each other, but yet still cooperate or interact with each other. The embodiments are not limited in this context.

As used herein, the terms “comprises,” “comprising,” “includes,” “including,” “has,” “having” or any other variation thereof, are intended to cover a non-exclusive inclusion. For example, a process, method, article, or apparatus that comprises a list of elements is not necessarily limited to only those elements but may include other elements not expressly listed or inherent to such process, method, article, or apparatus. Further, unless expressly stated to the contrary, “or” refers to an inclusive or and not to an exclusive or. For example, a condition A or B is satisfied by any one of the following: A is true (or present) and B is false (or not present), A is false (or not present) and B is true (or present), and both A and B are true (or present).

In addition, use of the “a” or “an” are employed to describe elements and components of the embodiments herein. This is done merely for convenience and to give a general sense of the description. This description, and the claims that follow, should be read to include one or at least one and the singular also may include the plural unless it is obvious that it is meant otherwise.

This detailed description is to be construed as examples and does not describe every possible embodiment, as describing every possible embodiment would be impractical, if not impossible. One could implement numerous alternate embodiments, using either current technology or technology developed after the filing date of this application.

Upon reading this disclosure, those of skill in the art will appreciate still additional alternative structural and functional designs for evaluation properties, through the principles disclosed herein. Therefore, while particular embodiments and applications have been illustrated and described, it is to be understood that the disclosed embodiments are not limited to the precise construction and components disclosed herein. Various modifications, changes and variations, which will be apparent to those skilled in the art, may be made in the arrangement, operation and details of the method and apparatus disclosed herein without departing from the spirit and scope defined in the appended claims.

The patent claims at the end of this patent application are not intended to be construed under 35 U.S.C. § 112(f) unless traditional means-plus-function language is expressly recited, such as “means for” or “step for” language being explicitly recited in the claim(s). The systems and methods described herein are directed to an improvement to computer functionality, and improve the functioning of conventional computers.

What is claimed:

1. A system for preserving memories and experiences through a Non-Fungible Token (NFT) engine, the system comprising:
one or more memories storing a set of computer-readable instructions including the NFT engine; and
one or more processors interfacing with the one or more memories, and configured to execute the set of computer-readable instructions to cause the system to:
receive data of a user from a time period, and
execute the NFT engine to:
analyze the data to classify a memory experienced by the user during the time period based on a memory threshold,
generate, for display to the user, an NFT based on the memory, and
mint the NFT corresponding to the memory to a blockchain, wherein a portion of the data associated with the memory is linked to the NFT.

2. The system of claim 1, wherein:
the system further comprises a sensory feedback system;
the time period is a first time period; and
the set of computer-readable instructions further cause the system to:
access the data linked to the NFT during a second time period that is different from the first time period,
display, via the sensory feedback system, a recreation of the memory for the user based on the data, and
cause the sensory feedback system to provide sensory feedback to the user in conjunction with the recreation.

3. The system of claim 2, wherein the sensory feedback includes one or more of: (i) visual feedback, (ii) audio feedback, (iii) haptic feedback, or (iv) olfactory feedback.

4. The system of claim 1, wherein:
the system further comprises a plurality of sensors;
the set of computer-readable instructions further cause the system to capture, by the plurality of sensors, the data of the user from the time period; and
the data of the user includes one or more of: (i) heartbeat data, (ii) brainwave data, (iii) emotional context data, (iv) scent data, (v) temperature data, (vi) audio data, (vii) image data, or (viii) video data.

5. The system of claim 1, wherein the set of computer-readable instructions further cause the system to:
aggregate the data from a plurality of data sources including one or more of: (i) a wearable device, (ii) a smart home device, (iii) a social media platform, or (iv) a user computing device; and
determine, by a contextual memory detection algorithm, whether the data satisfies the memory threshold based on a plurality of thresholds associated with the plurality of data sources.

6. The system of claim 5, wherein the set of computer-readable instructions further cause the system to enrich the data associated with the memory by:
layering, into the data from at least one of the plurality of data sources, one or more of: (i) a photo, (ii) a video, (iii) an audio track, or (iv) a text sequence corresponding to the memory that was not included in the data, or
generating, by the contextual memory detection algorithm, a contextual narrative configured to explain one or more of: (i) a backstory, (ii) a character, (iii) an emotion.

7. The system of claim 1, wherein the set of computer-readable instructions further cause the system to:
determine an experience within the memory based on the data satisfying the memory threshold and an experience threshold that is different from the memory threshold;
generate, for display to the user, a second NFT based on the experience; and
mint the second NFT corresponding to the experience to the blockchain, wherein a second portion of the data associated with the memory is linked to the second NFT.

8. The system of claim 1, wherein the set of computer-readable instructions further cause the system to:
receive, from the user, an approval indication or a rejection indication corresponding to the NFT;
responsive to receiving the rejection indication, prompt the user to provide supplemental data corresponding to the memory; and
generate a second NFT based on the memory and the supplemental data.

9. A computer-implemented method for preserving memories and experiences through a Non-Fungible Token (NFT) engine, the method comprising:
receiving, at one or more processors, data of a user from a time period; and
executing, by the one or more processors, the NFT engine to:
analyze the data to classify a memory experienced by the user during the time period based on a memory threshold,
generate, for display to the user, an NFT based on the memory, and
mint the NFT corresponding to the memory to a blockchain, wherein a portion of the data associated with the memory is linked to the NFT.

10. The computer-implemented method of claim 9, wherein the time period is a first time period, and the method further comprises:
accessing, by the one or more processors, the data linked to the NFT during a second time period that is different from the first time period;
displaying, via a sensory feedback system, a recreation of the memory for the user based on the data; and
causing, by the one or more processors, the sensory feedback system to provide sensory feedback to the user in conjunction with the recreation.

11. The computer-implemented method of claim 10, wherein the sensory feedback includes one or more of: (i) visual feedback, (ii) audio feedback, (iii) haptic feedback, or (iv) olfactory feedback.

12. The computer-implemented method of claim 9, further comprising:
capturing, by a plurality of sensors, the data of the user from the time period, wherein the data of the user includes one or more of: (i) heartbeat data, (ii) brainwave data, (iii) emotional context data, (iv) scent data, (v) temperature data, (vi) audio data, (vii) image data, or (viii) video data.

13. The computer-implemented method of claim 9, further comprising:
aggregating, by the one or more processors, the data from a plurality of data sources including one or more of: (i) a wearable device, (ii) a smart home device, (iii) a social media platform, or (iv) a user computing device; and
determining, by the one or more processors executing a contextual memory detection algorithm, whether the data satisfies the memory threshold based on a plurality of thresholds associated with the plurality of data sources.

14. The computer-implemented method of claim 13, further comprising:
enriching, by the one or more processors, the data associated with the memory by:
layering, into the data from at least one of the plurality of data sources, one or more of: (i) a photo, (ii) a video, (iii) an audio track, or (iv) a text sequence corresponding to the memory that was not included in the data, or
generating, by the one or more processors executing the contextual memory detection algorithm, a contextual narrative configured to explain one or more of: (i) a backstory, (ii) a character, (iii) an emotion.

15. The computer-implemented method of claim 9, further comprising:
determining, by the one or more processors, an experience within the memory based on the data satisfying the memory threshold and an experience threshold that is different from the memory threshold;
generating, by the one or more processors and for display to the user, a second NFT based on the experience; and
minting, by the one or more processors, the second NFT corresponding to the experience to the blockchain, wherein a second portion of the data associated with the memory is linked to the second NFT.

16. A tangible, non-transitory computer-readable medium storing instructions for preserving memories and experiences through a Non-Fungible Token (NFT) engine that, when executed by one or more processors of a computing device, cause the computing device to:
receive data of a user from a time period; and
execute the NFT engine to:
analyze the data to classify a memory experienced by the user during the time period based on a memory threshold,
generate, for display to the user, an NFT based on the memory, and
mint the NFT corresponding to the memory to a blockchain, wherein a portion of the data associated with the memory is linked to the NFT.

17. The tangible, non-transitory computer-readable medium of claim 16, wherein the time period is a first time period, and the instructions, when executed, further cause the computing device to:
access the data linked to the NFT during a second time period that is different from the first time period;
display, via a sensory feedback system, a recreation of the memory for the user based on the data; and
cause the sensory feedback system to provide sensory feedback to the user in conjunction with the recreation, and
wherein the sensory feedback includes one or more of: (i) visual feedback, (ii) audio feedback, (iii) haptic feedback, or (iv) olfactory feedback.

18. The tangible, non-transitory computer-readable medium of claim 16, wherein the instructions, when executed, further cause the computing device to:
capture, by a plurality of sensors, the data of the user from the time period, and
wherein the data of the user includes one or more of: (i) heartbeat data, (ii) brainwave data, (iii) emotional context data, (iv) scent data, (v) temperature data, (vi) audio data, (vii) image data, or (viii) video data.

19. The tangible, non-transitory computer-readable medium of claim 16, wherein the instructions, when executed, further cause the computing device to:
aggregate the data from a plurality of data sources including one or more of: (i) a wearable device, (ii) a smart home device, (iii) a social media platform, or (iv) a user computing device;
determine, by executing a contextual memory detection algorithm, whether the data satisfies the memory threshold based on a plurality of thresholds associated with the plurality of data sources; and
enrich the data associated with the memory by:
layer, into the data from at least one of the plurality of data sources, one or more of: (i) a photo, (ii) a video, (iii) an audio track, or (iv) a text sequence corresponding to the memory that was not included in the data, or
generate, by executing the contextual memory detection algorithm, a contextual narrative configured to explain one or more of: (i) a backstory, (ii) a character, (iii) an emotion.

20. The tangible, non-transitory computer-readable medium of claim 16, wherein the instructions, when executed, further cause the computing device to:
determine an experience within the memory based on the data satisfying the memory threshold and an experience threshold that is different from the memory threshold;
generate, for display to the user, a second NFT based on the experience; and
mint the second NFT corresponding to the experience to the blockchain, wherein a second portion of the data associated with the memory is linked to the second NFT.
